(19) United States
(12) Patent Application Publication
(10) Pub. No.: US 2011/0277409 A1
(43) Pub. Date: Nov. 17, 2011

(54) Wood planks with brick-like surface features and method of making same

(76) Inventor: David J. Atkinson, Loganville, GA (US)

(21) Appl. No.: 12/779,572

(22) Filed: May 13, 2010

(51) Int. Cl. E04B 2/10; B27M 1/08; B26D 3/00; E04B 2/08; E04F 13/076

(52) U.S. Cl. 52/387; 52/588.1; 52/389; 52/582.1; 83/39; 144/371

(57) ABSTRACT

A plank has a simulated brick front surface formed on a board. The board has a horizontal first lap cut into a first edge of the board defined by a first shoulder and a first cheek. The first shoulder has a first shoulder distance and the first cheek has a first cheek distance. The board has a horizontal second lap cut into the second edge of the board that is defined by a second shoulder and a second cheek. The second shoulder has a second shoulder distance and the second cheek has a second cheek distance. The second shoulder distance is substantially equal to the first shoulder distance subtracted from the thickness of the board. The second cheek distance is substantially equal to a width of a brick mortar joint subtracted from the first cheek distance. A plurality of evenly spaced vertical transverse grooves is cut into the front side.

### BACKGROUND OF THE INVENTION

1. Field of the Invention

The present invention relates to carpentry materials and, more specifically, to a plank used in finishing a wall.

2. Description of the Related Art

Brick veneer is frequently used in construction to provide structures with a desirable appearance. Brick veneer is typically made by arranging bricks in a common brick bond pattern and cementing them together with a mortar. While such a veneer is visually attractive, it can be quite costly and may overload supporting structures in certain applications.

Several types of artificial brick surfaces have been attempted, but they often tend to lack the appearance of quality. For example, wall paper, vinyl sheets and fiberboard sheets with images of brick walls printed thereon may give an appearance of brick at a distance, but they clearly look artificial at close range. Certain users, such as restaurants, bars, retailers and homeowners desire high quality finishes to their structures, while minimizing cost an structural loading. Such users often find that artificial brick surfaces are perceived as having an unacceptable look of low quality.

Therefore, there is a need for a system of generating a veneer that has a high quality appearance of brick, but that is low in cost and structural loading.

### SUMMARY OF THE INVENTION

The disadvantages of the prior art are overcome by the present invention which, in one aspect, is a method of making a plank having a simulated brick front surface from an elongated board having a length, a thickness, a front side, an opposite back side, a first edge, an opposite second edge, a first end and an opposite second end. An elongated horizontal first lap cut is cut into the first edge of the board along the length of the board. The first lap cut is defined by a first shoulder parallel to the first edge and a first cheek parallel to the back side. The first shoulder has a first shoulder distance that is defined by a distance between the first shoulder and the first edge and the first cheek having a first cheek distance. An elongated horizontal second lap cut is cut into the second edge of the board along the length of the board. The second lap cut is defined by a second shoulder parallel to the second edge and a second cheek parallel to the back side. The second shoulder has a second shoulder distance defined by a distance between the second shoulder and the second edge. The second cheek has a second cheek distance. The second shoulder distance is substantially equal to the first shoulder distance subtracted from the thickness of the board. The second cheek distance is substantially equal to a width of a brick mortar joint subtracted from the first cheek distance. A plurality of evenly spaced vertical grooves that are transverse to the first edge is cross cut on the front side. Each groove is spaced apart from an adjacent groove at a distance corresponding to a width of a brick. Each groove has a width corresponding to the width of a brick mortar joint. Each groove has a depth sufficient to receive therein a mortar-like substance so that the mortar-like substance can maintain stability in the groove while not extending outside of the groove. A plurality of chamfers are cut, including: a first elongated chamfer along a first corner defined by the front side and the first shoulder; a second elongated chamfer along a second corner defined by the front side and the second edge; a second vertical chamfer along a second vertical corner defined by each of the plurality of vertical grooves and the front side; and a first vertical chamfer along a first vertical corner opposite from the second vertical corner and defined by each of the plurality of vertical grooves and the front side.

In another aspect, the invention is a plank having a simulated brick front surface that includes an elongated board having a thickness, a front side, an opposite back side, a first edge, an opposite second edge, a first end and an opposite second end. The board has a horizontal first lap cut into a first edge of the board. The first lap cut is defined by a first shoulder parallel to the first edge and a first cheek parallel to the back side. The first shoulder has a first shoulder distance defined by a distance between the first shoulder and the first edge. The first cheek has a first cheek distance. The board has a horizontal second lap cut into the second edge of the board. The second lap cut is defined by a second shoulder parallel to the second edge and a second cheek parallel to the back side. The second shoulder has a second shoulder distance defined by a distance between the second shoulder and the second edge. The second cheek has a second cheek distance, the second shoulder distance is substantially equal to the first shoulder distance subtracted from the thickness of the board. The second cheek distance is substantially equal to a width of a brick mortar joint subtracted from the first cheek distance. A plurality of evenly spaced vertical grooves is cut into the front side. The grooves are transverse to the first edge. Each groove is spaced apart from an adjacent groove at a distance corresponding to a width of a brick. Each groove has a width corresponding to the width of a brick mortar joint. Each groove has a depth sufficient to maintain a mortar-like substance stably therein while not extending outside of the groove. The plank includes plurality of chamfers, including: a first elongated chamfer along a first corner defined by the front side and the first shoulder; a second elongated chamfer along a second corner defined by the front side and the second edge; a second vertical chamfer along a second vertical corner defined by each of the plurality of vertical grooves and the front side; and a first vertical chamfer along a first vertical corner opposite from the second vertical corner and defined by each of the plurality of vertical grooves and the front side.

In yet another aspect, the invention is a veneer surface that includes a plurality of planks, including at least a first plank and a second plank. Each of the plurality of planks includes an elongated board having a thickness, a front side, an opposite back side, a first edge, an opposite second edge, a first end and an opposite second end. A horizontal first lap is cut into a first edge of the board. The first lap cut is defined by a first shoulder parallel to the first edge and a first cheek parallel to the back side. The first shoulder has a first shoulder distance defined by a distance between the first shoulder and the first edge and the first cheek having a first cheek distance. A horizontal second lap is cut into the second edge of the board. The second lap cut is defined by a second shoulder parallel to the second edge and a second cheek parallel to the back side. The second shoulder has a second shoulder distance defined by a distance between the second shoulder and the second edge and the second cheek having a second cheek distance. The second shoulder distance is substantially equal to the first shoulder distance subtracted from the thickness of the board. The second cheek distance is substantially equal to a width of a brick mortar joint subtracted from the first cheek distance. A plurality of evenly spaced vertical grooves is cut into the front side and is transverse to the first edge. Each groove is spaced apart from an adjacent groove at a distance corresponding to a width of a brick. Each groove has a width corresponding to the width of a brick mortar joint. Each groove has a depth sufficient to maintain a mortar-like substance stably therein while not extending outside of the groove. A plurality of chamfers, includes a first elongated chamfer along a first corner defined by the front side and the first shoulder; a second elongated chamfer along a second corner defined by the front side and the second edge; a second vertical chamfer along a second vertical corner defined by each of the plurality of vertical grooves and the front side; and a first vertical chamfer along a first vertical corner opposite from the second vertical corner and defined by each of the plurality of vertical grooves and the front side. The back side of the second plank and the back side of the first plank are affixed to a vertical surface and the second cheek of the first plank is placed on first of the first cheek of the second plank so that the first edge of the second plank is in contact with the second shoulder of the first plank so that the first shoulder of the second plan and the second edge of the first plank define an elongated space therebetween having a distance corresponding to the width of a mortar joint.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIGS. 1A-1E are a plurality of schematic diagrams demonstrating one method of making a plank as disclosed herein.

FIG. 2 is a flowchart demonstrating one method of making a plank as disclosed herein.

FIG. 3 is a second front perspective view of a portion of one embodiment of a plank.

FIG. 4 is a cross-sectional view of several planks applied to a surface.

FIG. 5A is a front elevational view of a portion of one embodiment of a plank.

FIG. 5B is a first plan view of the embodiment shown in FIG. 6A.

FIG. 5C is a second plan view of the embodiment shown in FIG. 6A.

FIG. 5D is a back elevational view of the embodiment shown in FIG. 6A.

FIG. 5E is a left side view of the embodiment shown in FIG. 6A.

FIG. 5F is a right side view of the embodiment shown in FIG. 6A.

FIG. 6A is a front elevational view of a plank.

FIG. 6B is a first plan view of the plank shown in FIG. 7A.

FIG. 6C is a second plan view of the plank shown in FIG. 7A.

FIG. 6D is a back elevational view of the plank shown in FIG. 7A.

FIG. 6E is a left side view of the plank shown in FIG. 7A.

FIG. 6F is a right side view of the plank shown in FIG. 7A.

FIG. 7 is a front elevational view of a brick-like veneer employing planks of the type disclosed herein.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

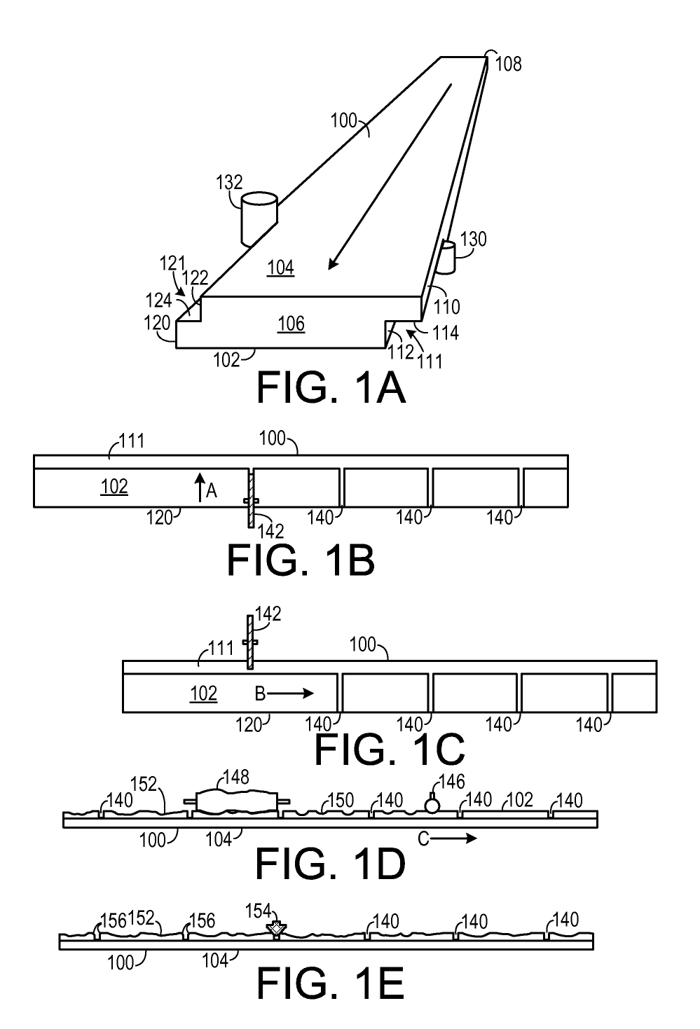

As shown in FIG. 1A, one embodiment is a method of making wood planks that can be used to build a high quality brick-like veneer surface. In the method, a first elongated lap 111 is cut into a first edge 110 of a wooden board 100 (which could include, for example, a softwood, such as pine or spruce, a hardwood, such as maple or cherry, a wood composite; or even a plastic in certain embodiments) using a first cutting tool 130 (which could be a tool such as: a milling head, a router, a shaper, a planer or a saw). The board 100 has a front side 102 and an opposite back side 104. The first lap 111 is defined by a first shoulder 112 and a first cheek 114 and opens to the front side 102 of the board 100. A second elongated lap 121 is cut into a second edge 120 of the board 100 using a second cutting tool 132 (which may a tool of the same type as the first cutting tool 130). The second lap 121 is defined by a second shoulder 122 and a second cheek 124. The widths of the first shoulder 112 and the second shoulder 122 are such that together they are substantially the same as the width of the board 100. The height of the first cheek 114 is equal to the height of the second cheek 124 plus the width of a desired gap between the front surfaces 102 of a first plank and a second plank when the first lap 111 of the first plank engages the second lap 121 of the second plank when the two planks are placed against each other. The desired gap would typically correspond to the width of a mortar joint in a brick veneer.

In the embodiment shown, the first cutting tool 130 and the second cutting tool 132 are in a fixed vertical relationship to a table (not shown). The board 100 is moved laterally on the table beginning at a first end 106 and pushed through the cutting tools 130, 132 until the first lap 111 and the second lap 121 are cut along the entire length of the board 100 to a second end 108.

As shown in FIGS. 1B-1C, a plurality of evenly spaced apart transverse grooves 140 is cross cut into the front surface 102 using, e.g., a cross cut saw 142. In one embodiment, the cross cut saw 142 uses a dado blade set at a width that corresponds to the width of a mortar joint in a brick veneer. The grooves 140 have a depth that would allow mortar-like substance to be placed and retained stably therein without having to extend beyond the front surface 102.

In one embodiment, the saw 142 is held in a fixed relationship to the table (not shown) and the board 100 is moved into the saw 142 in the direction of arrow A. Once the groove 140 is cut and the board is disengaged from the saw 142, then the board 100 is moved in the direction of arrow B by the length of a simulated brick and the process repeats itself until all of the grooves 140 are cut in the board 100. While only one cross cut saw 142 is shown, a plurality of spaced-apart saws may be used to cut a corresponding plurality of grooves 140 simultaneously to speed up the process.

As shown in FIG. 1D, the front surface 102 can be distressed to add a brick-like texture using a cutting tool 146 (such as, e.g., an overhead router with a ball shaped bit). The board can be placed on an oscillating table or otherwise wobbled (or the cutting tool can be wobbled with respect to the board in an alternate embodiment) to generate indentations 150 that have an irregular appearance. An additional molder 148 or other shaping tool can be used to add additional texture 152 to the front surface 102.

As shown in FIG. 1E, a chamfer 156 can be added to the edges of the grooves 140 and the board using a chamfering tool 154, such as a press pattern roller or a router with a chamfering bit (as shown). The chamfer 156 removes the sharp edges of the brick shape, thereby increasing the illusion of a brick like surface.

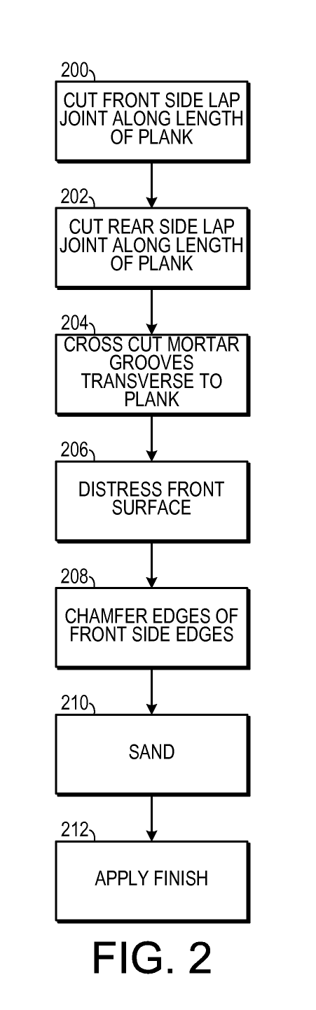

As shown in FIG. 2, the steps involved in making a plank with a brick-like surface include: cutting a front side lap joint along the length of the plank 200; cutting a rear side lap joint along the length of the plank 202 (these two steps could be executed simultaneously); cross-cutting mortar joint grooves transverse to the plank 204; distressing the front surface of the plank 206; chamfering the front side edges of the plank 208; sanding the plank 210; and applying a finish to the plank 212. The step of applying a finish 212 can be done during initial manufacturing or the planks can be sold in an unfinished state and the user can apply the finish at the construction site. The finish could include a stain that matches the color of real bricks to give the resulting bricks a natural brick-like appearance, or it could be a finish purposely designed to give the resulting planks a non-brick appearance, such as by using a clear varnish.

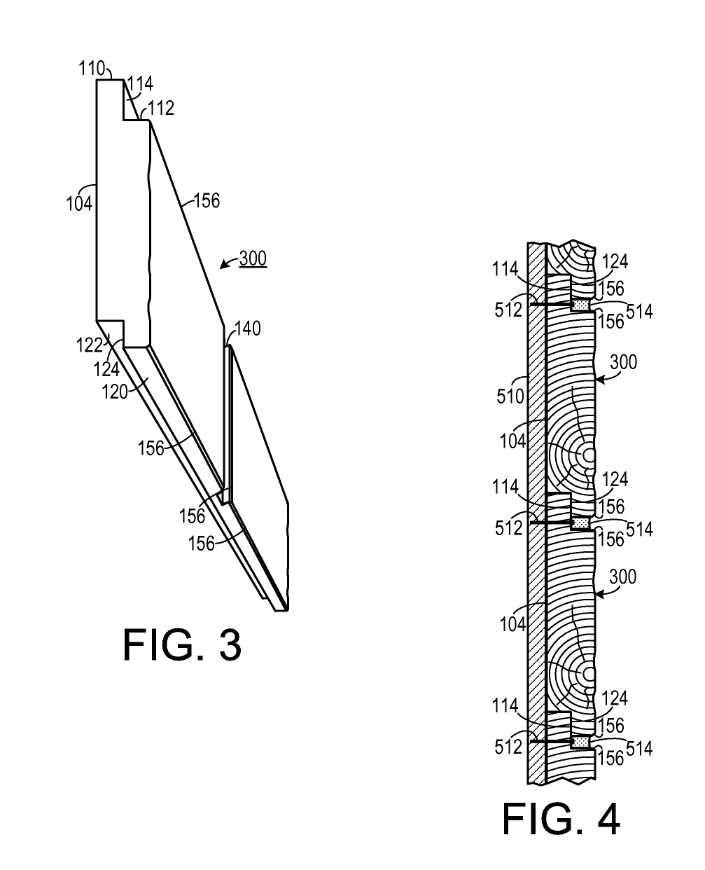

A perspective view of a section of a plank 300 made according to the method disclosed above is shown in FIG. 3. A cross-sectional view of several planks 300 installed on a surface 510 (which could be, e.g., a wall or bare studs) with nails 512 is shown in FIG. 4. In such an installation, the planks 300 could be affixed to the surface with an adhesive applied to the back surface 104 and then nailed in place to provide a secure attachment. It would be possible in certain embodiments to use only an adhesive or only nails. The adhesive (such as construction adhesive or carpenters glue) could be applied to the back surface 104 at the construction site, or it could pre-applied at the factory and be provided with a peel-and-stick cover sheet.

Once the planks are installed, an illusion of them being mortared together may be created by placing a mortar-like substance 514 in the gaps between the planks 300 and in the transverse grooves 140. The mortar-like substance 514 could be a grout, a grout caulk (although it has a rubberier feel than actual grout), a mortar caulk; a caulk, a stain, a paint and combinations thereof. If a paint or stain is used, the gaps will have a more mortar-like appearance if the paint or stain is of a color that contrasts with the finish on the front sides of the planks 300. When the planks 300 are arranged in the manner shown in FIG. 4, they provide a watertight surface that prevents water leaking from the front surface 102 to the back surface 104 in exterior applications.

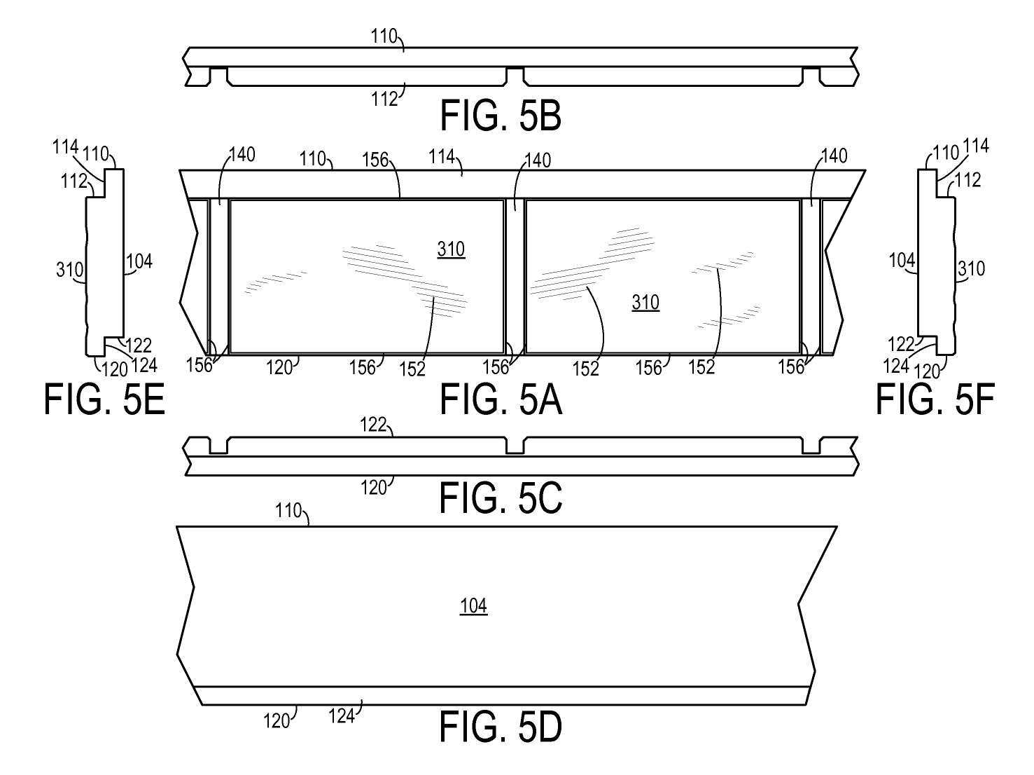

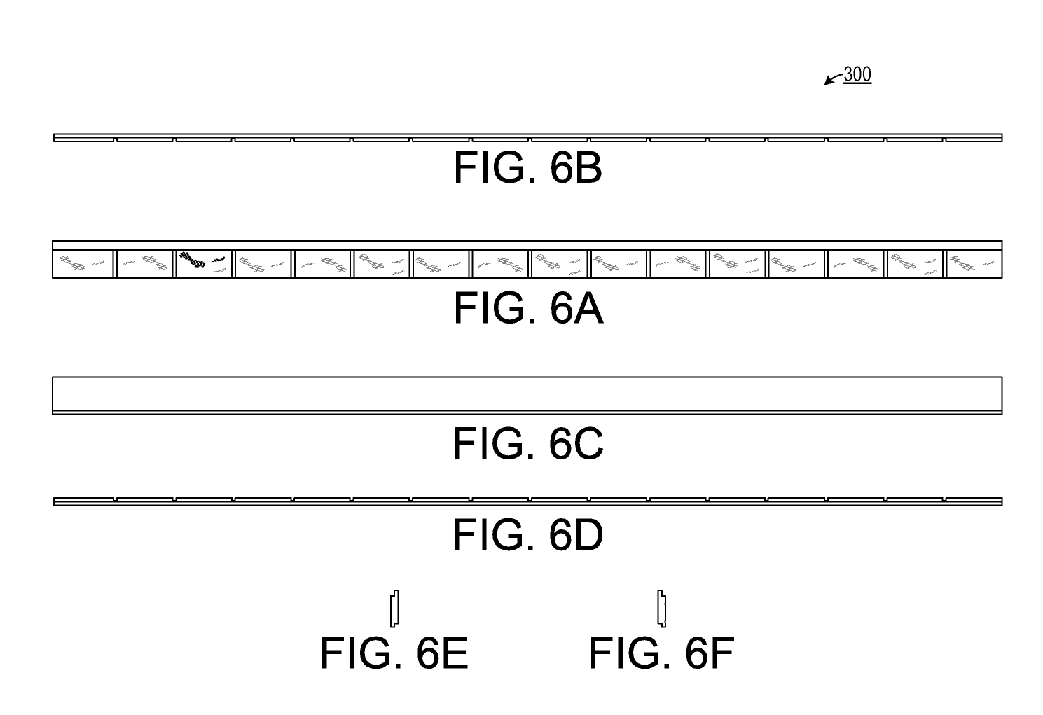

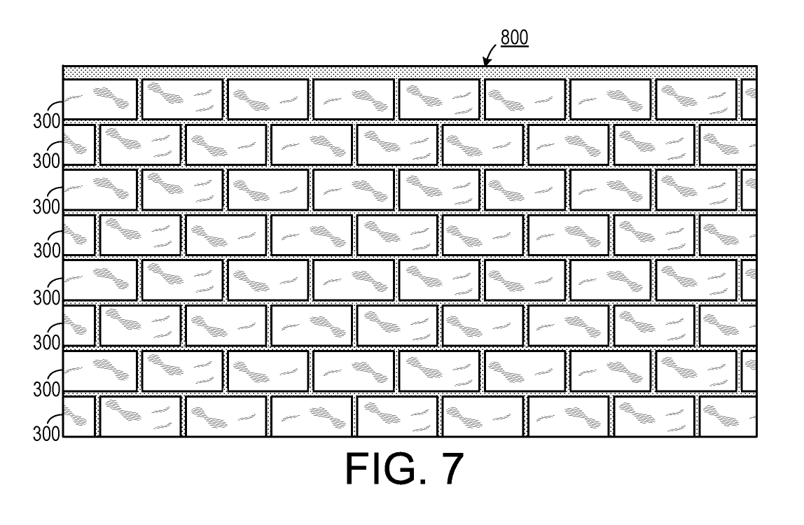

Various views of a section of a plank made according to the disclosure above are shown in FIGS. 5A-5F and various views of an entire plank are shown in FIGS. 6A-6F.

A front view of a veneer surface 800 using the planks 300 disclosed herein is shown in FIG. 7. In this figure, the planks are staggered so that the vertical grooves 140 are offset from each other so as to give an appearance of a brick bond pattern.

The simulated brick made from wood can be used by the home owner to enhance the home with the appearance of brick, while avoiding the cost and mess associated with real brick. It can be used in many applications, including: kitchens and bathroom (as in backsplashes), to create focal point columns, wainscoting, furniture and many other applications. If it is used near heat sources, it should be make of a fire-resistant material.

The planks can be installed on many different types of surfaces, including walls, bare studs and smaller structures (e.g., bars, desks, etc.). When installing, the surface is cleaned of dust. A first plank is leveled and affixed at the bottom with an adhesive and several finish nails. A second plank is leveled and applied to the surface, which can be accomplished by applying an adhesive thereto. The second plank can then be nailed to the surface or the studs through the first cheek, with the nail adjacent to the first shoulder of the plank. The next plank is applied to the surface so that the second cheek of the next plank is placed on first of the first cheek of the second plank and so that the second shoulder of the next plank is in contact with the first edge of the second plank, as so on. The vertical grooves of each successive plank can be offset from the vertical grooves of the previous plank so as to give the appearance of a brick bond layout (e.g., a running bond, a common bond, etc.).

The level of about every third plank should be checked to ensure that the entire resulting surface has the appearance of a well laid brick wall.

The planks can then be stained. Use of a dark stain on the front surfaces and a lighter stain or paint in the vertical grooves and spaces defined between the planks gives the appearance of brick. One can also apply actual masonry mortar, tile grout, tile grout caulk, mortar caulk or another type of caulk to enhance the illusion of brick.

In one commercial embodiment the planks are made in 3½″×8′ lengths with horizontal and vertical mortar lines and lap joints (also referred to herein as “transverse grooves”). The lap joints create the appearance of a ½″ horizontal mortar line. The lap joints overlay each other resulting in a solid sheet veneer surface.

In one embodiment, the lap joints are cut to 7/16″× 13/16″ on the male side and 7/16″×¼″ on the female side. The planks in this embodiment use 11/16″×3 7/16″ pine (although other species of wood could be used depending on the specific result desired). Each brick-like shape measures: 2 9/16″×8⅛″ with mortar lines (grooves) that measure ½″ wide and ¼″ deep. The front surface and edges are distressed to resemble actual masonry brick. The planks may be made as a stain grade or paint grade product.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of making a plank having a simulated brick front surface from an elongated board having a length, a thickness, a front side, an opposite back side, a first edge, an opposite second edge, a second end and an opposite first end, the method comprising the steps of:
a. cutting an elongated horizontal first lap cut into the first edge of the board along the length of the board, the first lap cut defined by a first shoulder parallel to the first edge and a first cheek parallel to the back side, the first shoulder having a first shoulder distance defined by a distance between the first shoulder and the first edge and the first cheek having a first cheek distance;
b. cutting an elongated horizontal second lap cut into the second edge of the board along the length of the board, the second lap cut defined by a second shoulder parallel to the second edge and a second cheek parallel to the back side, the second shoulder having a second shoulder distance defined by a distance between the second shoulder and the second edge and the second cheek having a second cheek distance, the second shoulder distance substantially equal to the first shoulder distance subtracted from the thickness of the board, the second cheek distance substantially equal to a width of a brick mortar joint subtracted from the first cheek distance;
c. cross cutting on the front side a plurality of evenly spaced vertical grooves that are transverse to the first edge, each groove spaced apart from an adjacent groove at a distance corresponding to a width of a brick, each groove having a width corresponding to the width of a brick mortar joint, each groove having a depth sufficient to receive therein a mortar-like substance so that the mortar-like substance can maintain stability in the groove while not extending outside of the groove; and
d. cutting a plurality of chamfers, including: a first elongated chamfer along a first corner defined by the front side and the first shoulder; a second elongated chamfer along a second corner defined by the front side and the second edge; a second vertical chamfer along a second vertical corner defined by each of the plurality of vertical grooves and the front side; and a first vertical chamfer along a first vertical corner opposite from the second vertical corner and defined by each of the plurality of vertical grooves and the front side.

2. The method of claim 1, further comprising the step of distressing at least a portion of the front side so as to create a texture simulating a textural feature found in bricks.

3. The method of claim 2, wherein the distressing step comprises the steps of:
a. placing the back side of the board on an oscillating table;
b. applying an overhead router to the portion of the front side; and
c. applying a molder to a portion of the front side.

4. The method of claim 3, wherein the step of applying an overhead router comprises wobbling a selected one of the board or the router so as to create irregularities in the texture.

5. The method of claim 1, wherein the board comprises a wood board.

6. The method of claim 1, the step of cutting a plurality of chamfers comprises applying a press pattern roller to the front side.

7. The method of claim 1, the step of cutting a plurality of chamfers comprises applying a router with a chamfer bit to the front side.

8. The method of claim 1, further comprising the step of sanding the front side.

9. The method of claim 1, further comprising the step of applying a finish to the front side.

10. A plank having a simulated brick front surface made according to the process recited in claim 1.

11. A plank having a simulated brick front surface, comprising:
a. an elongated board having a thickness, a front side, an opposite back side, a first edge, an opposite second edge, a second end and an opposite first end,
b. a horizontal first lap cut into a first edge of the board, the first lap cut defined by a first shoulder parallel to the first edge and a first cheek parallel to the back side, the first shoulder having a first shoulder distance defined by a distance between the first shoulder and the first edge and the first cheek having a first cheek distance;
c. a horizontal second lap cut into the second edge of the board, the second lap cut defined by a second shoulder parallel to the second edge and a second cheek parallel to the back side, the second shoulder having a second shoulder distance defined by a distance between the second shoulder and the second edge and the second cheek having a second cheek distance, the second shoulder distance substantially equal to the first shoulder distance subtracted from the thickness of the board, the second cheek distance substantially equal to a width of a brick mortar joint subtracted from the first cheek distance;
d. a plurality of evenly spaced vertical grooves, cut into the front side, that are transverse to the first edge, each groove being spaced apart from an adjacent groove at a distance corresponding to a width of a brick, each groove having a width corresponding to the width of a brick mortar joint, each groove having a depth sufficient to maintain a mortar-like substance stably therein while not extending outside of the groove; and
e. a plurality of chamfers, including: a first elongated chamfer along a first corner defined by the front side and the first shoulder; a second elongated chamfer along a second corner defined by the front side and the second edge; a second vertical chamfer along a second vertical corner defined by each of the plurality of vertical grooves and the front side; and a first vertical chamfer along a first vertical corner opposite from the second vertical corner and defined by each of the plurality of vertical grooves and the front side.

12. The plank of claim 11, further comprising a texture simulating a textural feature found in bricks cut into a portion of the front side.

13. The plank of claim 11, wherein the board comprises a material selected from a group consisting of: wood; wood composite; plastic; and combinations thereof.

14. The plank of claim 11, further comprising a finish applied to the front side.

15. A veneer surface comprising a plurality of planks, including at least a second plank and a first plank, each of the plurality of planks including:
a. an elongated board having a thickness, a front side, an opposite back side, a first edge, an opposite second edge, a second end and an opposite first end,
b. a horizontal first lap cut into a first edge of the board, the first lap cut defined by a first shoulder parallel to the first edge and a first cheek parallel to the back side, the first shoulder having a first shoulder distance defined by a distance between the first shoulder and the first edge and the first cheek having a first cheek distance;
c. a horizontal second lap cut into the second edge of the board, the second lap cut defined by a second shoulder parallel to the second edge and a second cheek parallel to the back side, the second shoulder having a second shoulder distance defined by a distance between the second shoulder and the second edge and the second cheek having a second cheek distance, the second shoulder distance substantially equal to the first shoulder distance subtracted from the thickness of the board, the second cheek distance substantially equal to a width of a brick mortar joint subtracted from the first cheek distance;
d. a plurality of evenly spaced vertical grooves, cut into the front side, that are transverse to the first edge, each groove being spaced apart from an adjacent groove at a distance corresponding to a width of a brick, each groove having a width corresponding to the width of a brick mortar joint, each groove having a depth sufficient to maintain a mortar-like substance stably therein while not extending outside of the groove; and
e. a plurality of chamfers, including: a first elongated chamfer along a first corner defined by the front side and the first shoulder; a second elongated chamfer along a second corner defined by the front side and the second edge; a second vertical chamfer along a second vertical corner defined by each of the plurality of vertical grooves and the front side; and a first vertical chamfer along a first vertical corner opposite from the second vertical corner and defined by each of the plurality of vertical grooves and the front side,
wherein the back side of the second plank and the back side of the first plank are affixed to a vertical surface and wherein the second cheek of the first plank is placed on first of the first cheek of the second plank and so that the first edge of the second plank is in contact with the second shoulder of the first plank, so that the first shoulder of the second plan and the second edge of the first plank define an elongated space therebetween having a distance corresponding to the width of a mortar joint.

16. The veneer surface of claim 15, further comprising a mortar-like material disposed in the vertical grooves of the planks and the elongated space defined between the second shoulder of the second plank and the first edge of the first plank.

17. The veneer surface of claim 16, wherein the mortar-like material comprises a substance selected from a group consisting of: a mortar; a grout, a grout caulk, a mortar caulk; a caulk, a stain, a paint and combinations thereof.

18. The veneer surface of claim 15, wherein the vertical grooves of the second plank are laterally offset from the vertical grooves of the first plank so as to give an appearance of brick bond pattern.

19. The veneer surface of claim 15, wherein each of the plurality of planks is nailed to the vertical surface.

20. The veneer surface of claim 15, wherein each of the plurality of planks is glued to the vertical surface.

21. The veneer surface of claim 15, wherein each of the plurality of planks further comprises a texture simulating a textural feature found in bricks cut into a portion of the front side.

22. The veneer surface of claim 15, wherein each elongated board comprises a material selected from a group consisting of: wood; wood composite; plastic; and combinations thereof.
